(19) United States
(12) Patent Application Publication
(10) Pub. No.: US 2008/0240759 A1
(43) Pub. Date: Oct. 2, 2008

(54) Developing device, image forming device, and image forming method

(75) Inventor: Ryouji Kouno, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/071,148

(22) Filed: Feb. 15, 2008

(30) Foreign Application Priority Data
Mar. 29, 2007 (JP) 2007-088100

(51) Int. Cl. G03G 15/06; G03G 13/04

(52) U.S. Cl. 399/55; 430/48

(57) ABSTRACT

A developer device applies bias voltage including an alternating-current component equal to or larger than a value corresponding to a developing electric field of 9 V/μm to a developing roller. The bias voltage is set to apply developer to a latent image on a photosensitive element to develop the image in an image forming mode. The bias voltage is set so that a difference between an area central potential and a surface potential of the photosensitive element is shifted to a direction attracting the normally charged developer to a developer carrier, in relation to a difference between an area central potential and a surface potential of the image carrier in the latent image section in the image forming mode, and a supply amount of the developer to the photosensitive element is smaller than that in the latent image section in the image forming mode.

### CROSS-REFERENCE TO RELATED APPLICATIONS

This application is based upon and claims the benefit of priority from the prior Japanese Patent Application No. 2007-88100 filed on Mar. 29, 2007, the entire contents of which are incorporated herein by reference.

### BACKGROUND OF THE INVENTION

1. Field of the Invention

The invention relates to a developing device of mono-component developing device for developing an electrostatic latent image on an image carrier by charged developer, an image forming device having such developing device, and an image forming method. More particularly the invention relates to a developing device for discarding deteriorated toner selectively by varying the relation of bias voltage and surface potential of the image carrier between an image forming mode and a non-forming mode, an image forming device, and an image forming method.

2. Description of Related Art

In some of developing devices of mono-component developing system, developer is charged by making use of friction or the like. The developer is controlled to a specified thickness by using a regulating plate or the like, and is carried on the surface of a developer carrier. When forming an image, an image carrier is charged to a specified potential, and is partly changed in potential level by exposure. The exposed portion is an image area, and a non-exposed portion is a background area. Thus, an electrostatic latent image is formed, and is developed by the developing device. At this time, to the developer carrier of the developing device, generally, a superimposed voltage of direct-current voltage and alternating-current voltage is applied as a developing bias voltage.

As for such developing device, it is known that the toner deteriorates after a long time of use. In particular, this phenomenon of deterioration is apparent after printing many images having a low ratio of the image area. That is, when the toner is charged repeatedly but is used rarely, the charging characteristic of the toner worsens. Furthermore, if fresh toner is added in the developing device holding a large volume of the deteriorated toner, the deteriorated toner further deteriorates due to difference in charging characteristic between the deteriorated toner and the fresh toner. Hence, the developing device after a long time of use contains a weakly-charged toner, and an inverted toner charged in reverse polarity.

To prevent decline of image quality due to deterioration of toner, hitherto, it has been proposed to use an image forming device designed to consume the developer by force in a non-image region (see, for example, JP3-54582(1991)A). In this device, when a condition of increasing the deteriorated toner is fulfilled, a relatively large portion of the toner is discarded by force. It is explained that the toner is maintained in a relatively favorable state on the whole as a result.

Further, JP2004-29104A discloses an image forming device in which the potential difference between the potential in the background area in the non-image region of the image carrier and the direct-current component of developing bias voltage is set larger than the potential difference between the potential in the image area in the image region of the image carrier and the potential in the background area in a certain condition. According to this document, the inverted toner in the developing device is discarded by force, and decline of image quality is prevented in this device.

### SUMMARY OF THE INVENTION

However, in the image forming device disclosed in JP'582A, at the time of forced discard, not only the deteriorated toner, but also the normal toner is discarded massively. As a result, the toner consumption is large. In the image forming device disclosed in JP'104A, if the inverted toner charge in reverse polarity may be discarded, the weakly-charged toner cannot be discarded. Further, according to the experiment by the present inventors, the inverted toner was not discarded sufficiently.

The invention is conceived to solve the above problems of the existing developing devices. It is hence an object thereof to provide a developing device, and an image forming device and an image forming method capable of discarding the inverted toner and the weakly-charged toner selectively without excessively consuming the toner, and maintaining the toner in a favorable charging characteristic.

To achieve the above object, the present invention provides a developing device comprising a developer carrier for carrying charged nonmagnetic mono-component developer and conveying the developer toward a developing region opposite to an image carrier across a gap, and a bias power source for applying bias voltage including an alternating-current component to the developer carrier to develop a latent image on the image carrier, wherein the bias power source is arranged:
to set the bias voltage in an image forming mode so that an amplitude of the alternating-current component is equal to or larger than a value corresponding to a developing electric field of 9 V/μm, and a latent image on the image carrier is developed by applying with developer; and
to set the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted to a direction attracting normally charged developer to the developer carrier, in relation to a difference between an area central potential and a surface potential of the image carrier in a latent image section in the image forming mode; and an amount of the developer to be supplied to the image carrier is smaller than that in the latent image section in the image forming mode.

According to another aspect, the present invention provides an image forming device comprising an image carrier, a charging device for charging a surface of the image carrier, an exposing device for exposing the charged image carrier and a developing device for developing a latent image on the image carrier, the developing device including a developer carrier for carrying charged nonmagnetic mono-component developer and conveying the developer toward a developing region opposite to an image carrier across a gap, and a bias power source for applying a bias voltage including an alternating-current component to the developer carrier, wherein the bias power source is arranged:
to set the bias voltage in an image forming mode so that an amplitude of the alternating-current component is equal to or larger than a value corresponding to a developing electric field of 9 V/μm, and a latent image on the image carrier is developed by applying with developer; and
to set the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted to a direction attracting normally charged developer to the developer carrier, in relation to the difference between an area central potential and a surface potential of the image carrier in a latent image section in the image forming mode; and an amount of the developer to be supplied to the image carrier is smaller than that in the latent image section in the image forming mode.

Furthermore, according to another aspect, the present invention provides an image forming method for forming an image in such a manner that charged nonmagnetic mono-component developer is carried by a developer carrier placed opposite to an image carrier across a gap, the developer is conveyed toward a developing region of the image carrier, and bias voltage including an alternating-current component is applied to the developer carrier to develop a latent image on the image carrier, the method comprising the steps of:
setting the bias voltage in an image forming mode so that an amplitude of the alternating-current component is equal to or larger than a value corresponding to a developing electric field of 9 V/μm, and a latent image on the image carrier is developed by applying with developer; and
setting the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted to a direction attracting normally charged developer to the developer carrier, in relation to a difference between an area central potential and a surface potential of the image carrier in a latent image section in the image forming mode; and an amount of the developer to be supplied to the image carrier is smaller than that in the latent image section in the image forming mode.

According to the developer device, image forming apparatus, and image forming method of the present invention, it is possible to discard the inverted toner and the weakly-charged toner selectively without excessively consuming the toner, and maintaining the toner in a favorable charging characteristic.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a main part of an image forming device in a preferred embodiment;

FIG. 2 is a voltage waveform diagram showing an example of a developing bias voltage;

FIG. 3 is a schematic diagram showing a stage where toner flies by developing bias voltage;

FIG. 4 is a graph showing a relationship between parameters of developing bias voltage and image density;

FIG. 5 is a graph showing a relationship between parameters of developing bias voltage and image density;

FIG. 6 is a voltage waveform diagram showing an example of developing bias voltage in non-image-forming mode;

FIG. 7 is a voltage waveform diagram showing an example of developing bias voltage in non-image-forming mode;

FIG. 8 is a voltage waveform diagram showing an example of developing bias voltage in non-image-forming mode;

FIG. 9 is a voltage waveform diagram showing an example of developing bias voltage in non-image-forming mode;

FIG. 10 is a sectional view showing an example of a developing device in the present embodiment;

FIG. 11 is a graph showing changes in charge amount distribution of toner on a developing roller;

FIG. 12 is a graph showing charge amount distribution of toner on a photosensitive element after experiment;

FIG. 13 is a graph showing changes in charge amount distribution of toner on a developing roller; and

FIG. 14 is a graph showing changes in charge amount distribution of toner on a developing roller.

### DETAILED DESCRIPTION OF THE PREFERRED EMBODIMENTS

A preferred embodiment of the invention is specifically described below with reference to the accompanying drawings. The embodiment is an application of the invention in an image forming device of an electrophotographic system having a developing device of mono-component developing system.

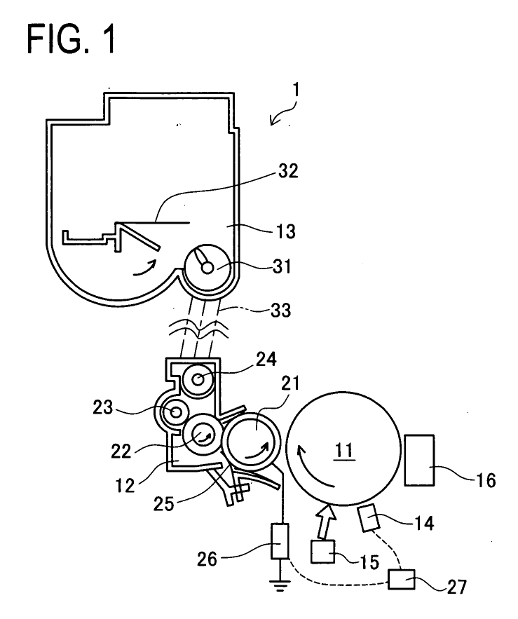

An image forming device 1 of the embodiment mainly includes, as shown in FIG. 1, a photosensitive element 11, a developing device 12, and a hopper 13. The photosensitive element 11 is surrounded by a charging device 14 for charging the surface of the photosensitive element 11 at a specified potential, an exposure device 15 for forming a latent image by emitting laser light to the surface of the photosensitive element 11, and a cleaner 16 for collecting the residual toner on the photosensitive element 11. In this image forming device 1, the hopper 13 is provided separately from the developing device 12, but the invention may be applied to an image forming device having a disposable type developing device integrated with a hopper.

The developing device 12 includes, as shown in FIG. 1, a developing roller 21, a supplying roller 22, an agitating roller 23, a conveying roller 24, and a regulating member 25. A power source 26 is provided for applying a developing bias voltage to the developing roller 21. A control unit 27 is provided for controlling the charging device 14 and the power source 26. The hopper 13 is provided with a conveying member 31 and an agitating member 32. Between the hopper 13 and the developing device 12, a conveying route 33 is formed for conveying the toner. In the embodiment, the toner is a nonmagnetic mono-component toner of a negative charging type.

A proper amount of toner is contained in the developing device 12, and is used for forming an image, and is properly agitated by the agitating roller 23. Fresh toner is contained in the hopper 13, and is stirred by the agitating member 32 rotating as indicated by arrow in FIG. 1. When the toner in the developing device 12 is spent and is lowered in the remaining volume, fresh toner is supplied into the developing device 12 from the hopper 13. At this time, the toner is supplied into the developing device 12 through the conveying route 33 by the conveying member 31. In the developing device 12, it is conveyed in a depth direction (axial direction of the photosensitive element 11) by the conveying roller 24.

When forming an image, as indicated by arrow in FIG. 1, the photosensitive element 11, the supplying roller 22, and the developing roller 21 are rotated. The toner is supplied on the surface of the developing roller 21 by the supplying roller 22. The supplied toner is regulated in film thickness and charged by the regulating member 25 along with rotation of the developing roller 21.

On the other hand, the photosensitive element 11 is uniformly charged negatively at its surface by the charging device 14, and is partly exposed by the exposure device 15, and an electrostatic latent image is formed at the surface. In the image forming device 1 of the embodiment, the portion charged by the charging device 14 but is not exposed becomes a background area. The background area is the portion to be free from the toner, and corresponds to a blank space of the image. The portion exposed by the exposure device 15 is an image area. That is, this is the area to be coated with the toner, and corresponds to a colored space of the image.

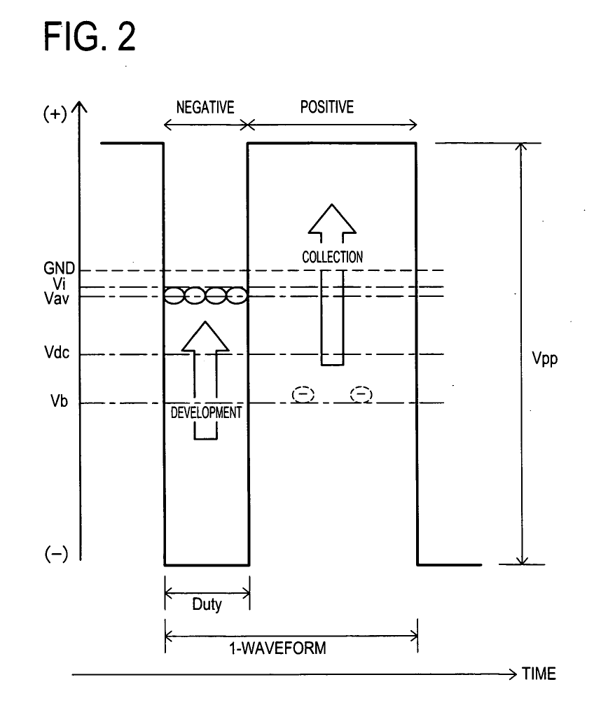

The portion of the photosensitive element 11 on which the electrostatic latent image is formed is further rotated, and comes to be opposite to the developing device 12. A developing bias voltage is applied to the developing roller 21 by the power source 26. This developing bias voltage is a superimposed voltage of a direct-current component and an alternating-current component. In this context, a square waveform as indicated by the thick line in FIG. 2 is used. In the embodiment, the developing roller 21 and the photosensitive element 11 do not contact with each other, but are disposed in parallel across a tiny gap. The portion of the developing roller 21 opposite in a developing range of the photosensitive element 11 is a developing region, and the portion of the photosensitive element 11 opposite to the developing region is a to-be-developed region.

In FIG. 2, the signs are meant as follows.
GND: Ground (potential 0V)
Vi: Image area potential (potential of the exposed portion within the surface of the photosensitive element 11)
Vb: Background area potential (potential of the non-exposed portion within the surface of the photosensitive element 11)
Vdc: Direct-current component of developing bias voltage
Vpp: Peak-to-peak voltage of the alternating-current component of developing bias voltage
Duty: Rate of developing side of one wavelength of developing bias voltage
Vav: Area central potential of developing bias voltage (calculated from Vdc, Vpp, Duty)

At this time, the surface potential of the photosensitive element 11 varies between the image area and the background area. The surface potential in the background area is a negative potential (Vb) in a state charged by the charging device 14. The surface potential in the image area is a positive-side potential (Vi) from the background area. The negatively charged toner gains electric energy from the developing roller 21, because a developing bias voltage as shown in FIG. 2 is applied to the developing roller 21. Basically, the negatively charged toner receives an upward force in FIG. 2.

The developing bias voltage is not always the same, but is controlled by the control unit 27 depending on, for example, setting of the image density. For example, the direct-current component (Vdc) of developing bias voltage, peak-to-peak voltage (Vpp) of the alternating-current component of developing bias voltage, and rate (Duty) of developing side of one wavelength of developing bias voltage are all designed to be variable depending on conditions.

The following shows a set of examples of the surface potential of the photosensitive element 11 and developing bias voltage in the image forming device 1 when forming an image.

Photosensitive element 11: Vi=−50 (V)

Vb=−500 (V)

Developing bias voltage: Vdc=−320 (V)

Vpp=1300 (V)

Duty=35 (%)

Vav=−125 (V)

The developing bias voltage is alternately repeated between positive voltage and negative voltage as shown in FIG. 2. When the developing bias voltage is a negative voltage, the toner flies from the developing roller 21 to the photosensitive element 11 by surpassing the gap between them. The majority of the flying toner particles sticks to the image area of the photosensitive element 11, and develops the electrostatic latent image. When the developing bias voltage is a positive voltage, mainly, the toner in the background area flies from the photosensitive element 11 to the developing roller 21 and is collected.

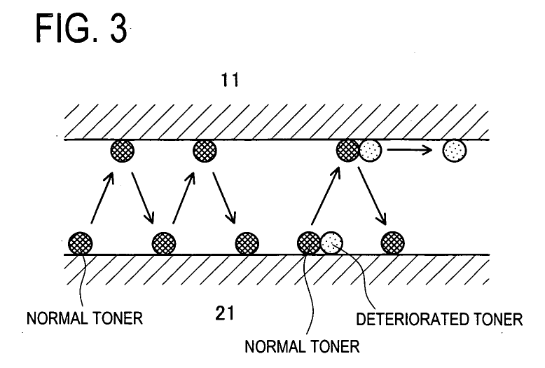

In this way, the toner sticks to the photosensitive element 11 in the image area to develop an image. On the other hand, the toner does not stick to the photosensitive element 11 and is collected in the background area. The inventor closely observed the behavior of the toner at this time, and discovered the fact that the toner is somewhat traveling to and fro between the photosensitive element 11 and the developing roller 21, whether in the image area or in the background area, in an applied state of developing bias voltage. As shown at the left side in FIG. 3, the toner gaining the flying power by the developing bias voltage surpasses the gap between the photosensitive element 11 and the developing roller 21, and repeats the travel several times.

In order that the toner can surpass the gap between the photosensitive element 11 and the developing roller 21, it is required that the developing electric field contains an alternating-current component of amplitude of 9 V/μm or more. This amplitude is obtained by dividing the peak-to-peak voltage (Vpp) of the alternating-current component of developing bias voltage by the gap (closest distance) between the photosensitive element 11 and the developing roller 21. For example, in the image forming device in which the closest distance of the photosensitive element 11 and the developing roller 21 is 135 μm, supposing Vpp=1300 (V), the amplitude is about 9.6 V/μm. The upper limit of the amplitude is a value not allowing discharge between the photosensitive element 11 and the developing roller 21, and the value differs depending on the direct-current component (Vdc) of the developing bias voltage.

The inverted toner charged in reverse polarity due to deterioration and the weakly-charged toner reduced in the amount of charge are both low in the absolute value of the amount of charge. The inverted toner is inverted in the charge polarity, and is weak in charge amount. Hence, at the ordinary developing bias voltage, it is now known that such deteriorated toner cannot obtain enough energy for departing from the developing roller 21 alone. Therefore, as in the image forming device of JP'104A cited in the background art, even if developing bias voltage of reverse polarity is applied, most of inverted toner particles cannot fly alone, and the amount of actually collected toner is limited.

It is found that such deteriorated toner sticks to the toner of normal charge amount and fly together with the normal toner, as shown at the right side in FIG. 3. When colliding against the photosensitive element 11 together with the toner of normal charge amount, the deteriorated toner may be separated from the toner of normal charge amount due to the impact. After separated from the normal toner and stuck to the photosensitive element 11, the deteriorated toner does not get enough energy to be separated from the photosensitive element 11 and collected even at the collecting side of the developing bias voltage.

Accordingly, the isolated deteriorated toner sticking to the photosensitive element 11 remains stuck to the photosensitive element 11. This phenomenon was similarly observed in both the background area and the image area of the photosensitive element 11. In particular, the toner remaining in the background area caused image fogging. Such isolated deteriorated toner is not collected easily even if the developing bias voltage in the collecting direction is increased.

The image forming device 1 of the embodiment positively builds up a circumstance for encouraging such phenomenon at the right side in FIG. 3 in the non-forming mode. That is, as compared with the forming mode, a circumstance is created in which traveling and flying of toner particles of normal charge amount is further encouraged. Finally, most toner particles of normal charge amount are preferably collected at the developing roller 21 side. On the other hand, it is preferred that the deteriorated toner cannot fly alone and can fly only together with the toner of normal charge amount. As a result, the deteriorated toner is mostly left over on the photosensitive element 11, and the toner of normal charge amount is mostly collected. Then the photosensitive element 11 is cleaned by the cleaner 16, and most of the deteriorated toner is removed selectively.

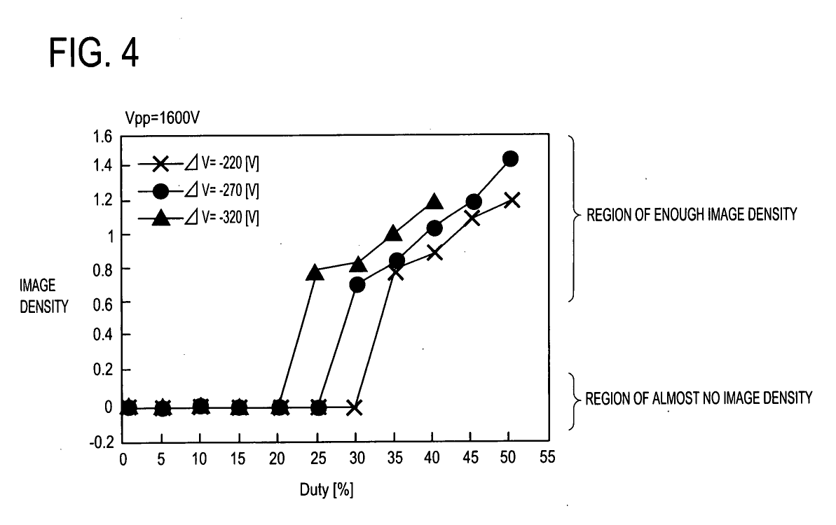

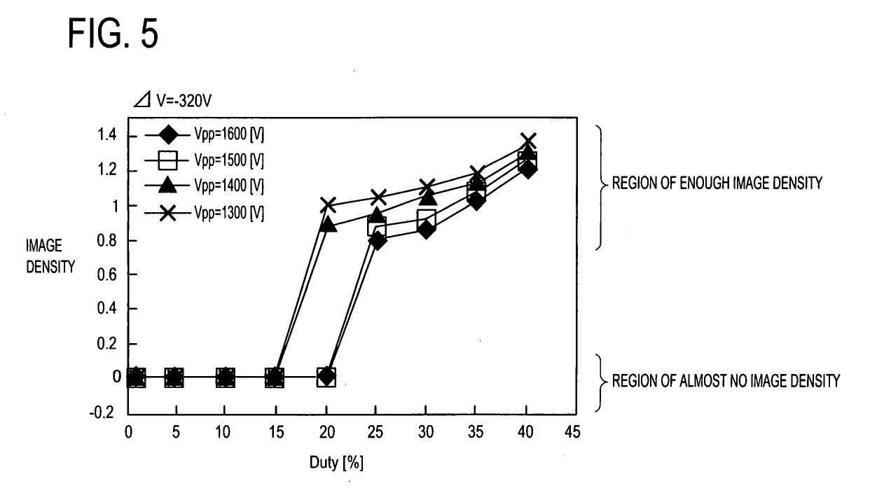

The relation between the surface potential of the photosensitive element 11 and developing bias voltage for creating this circumstance is explained below. The inventor applied developing bias voltages assigned with various parameters to the developing roller 21, printed specified images, and investigated the image density of the formed images. Results are shown in FIG. 4 and FIG. 5. The image density here is the density of the printed image, which corresponds to the quantity of the toner supplied on the photosensitive element 11. In the diagram, the region of zero image density means that the image density was hardly recognized in the region, not that the toner supply was exactly zero.

As shown in FIG. 4 and FIG. 5, the image forming device 1 was found to include both “region of enough image density” and “region of almost no image density” depending on changes of parameters of developing bias voltage. It is also known that the image density changes rapidly in the border area.

In the “region of almost no image density”, the quantity of the toner remaining on the photosensitive element 11 is sufficiently smaller than the supply of the developer on the latent image when forming an image, and the quantity is hardly recognized visually. This toner amount can be measured in the following procedure, for example, when a cyan toner is used. The toner on the photosensitive element 11 is peeled off by Book tape, and the tape is adhered to the standard paper (Konica-Minolta J paper), and C* is measured by using color difference meter CR241 manufactured by Konica-Minolta. In the “region of almost no image density”, the quantity of the toner remaining on the photosensitive element 11 was measured, and only about 5 was obtained as shown in the diagram.

The relation between parameters of developing bias voltage and image density is explained. FIG. 4 shows ΔV=−220, −270, −320 (V) at Vpp=1600, with Duty changed in a range of 0 to 50%. FIG. 5 shows ΔV=−320 (V), at various levels of Duty and Vpp. Herein, ΔV is the value expressed as follows.

ΔV=Vdc−Vi

where Vpp, Duty, Vdc, and Vi are as defined above.

As clear from FIG. 4 and FIG. 5, when Vpp and ΔV are fixed, by decreasing Duty from a specified value, a “region of almost no image density” is formed. As shown in FIG. 4, when Vpp and Duty are fixed, a “region of almost no image density” may be formed by decreasing ΔV from a specified value. Also as shown in FIG. 5, when ΔV and Duty are fixed, a “region of almost no image density” may be formed by increasing Vpp from a specified value.

In other words, the condition for changing the setting from “region of enough image density” to “region of almost no image density” includes any one of (1) decreasing of Duty, (2) increasing of Vpp, and (3) increasing of ΔV (decreasing of absolute value). At least one condition must be satisfied. As a result, other conditions may be assigned in the reverse condition.

Even in the “region of almost no image density”, by applying a developing bias voltage including the alternating-current component equivalent to amplitude 9 V/μm or more of developing electric field, it is now known that the toner can fly by surpassing the gap. In particular, when the developing bias voltage expands widely to the positive side and the negative side across the surface potential of the photosensitive element 11, the toner travels between the developing roller 21 and the photosensitive element 11. Therefore, when the developing bias voltage in this region is applied, most of the deteriorated toner is selectively left over on the photosensitive element 11, and the toner of normal charge amount is mostly collected on the developing roller 21.

In the image forming device 1 of the embodiment, the developing bias is changed from the normal level so as to form “region of almost no image density” in the non-forming mode. As a result, the deteriorated toner can be emitted on the photosensitive element 11 selectively in the non-forming mode. On the other hand, in the image forming mode, “region of enough image density” is used, and an image is formed favorably.

It is thus confirmed that “region of enough image density” and “region of almost no image density” are realized by changing one or more of Vpp, Duty, and ΔV. Hence, in the image forming device for developing a latent image on the photosensitive element 11 by applying a developing electric field of amplitude 9 V/μm or more between the developing roller 21 and the photosensitive element 11 mutually opposite across a gap by using nonmagnetic mono-component developer, the following facts are now known. That is, while keeping the amplitude of the alternating-current component at 9 V/μm or more, by setting at least one of Vpp, Duty, and ΔV different from the developing mode, when the supply amount of the developer in the photosensitive element 11 is smaller than the supply amount on the latent image in the image forming mode, the setting of Vpp, Duty, and ΔV at this time is in “region of almost no image density”.

Next, the condition of developing bias voltage for emitting the deteriorated toner in the non-forming mode is explained. First, the toner is needed to go back and forth between the photosensitive element 11 and the developing roller 21, so the developing bias voltage is applied by superposing the direct-current component and the alternating-current component same as when forming an image. At this time, the amplitude of the alternating-current component must be equivalent to 9 V/μm or more. The potential of the photosensitive element 11 is set between the maximum value and the minimum value of developing bias voltage. In the non-forming mode, no image is formed, and the potential of the photosensitive element 11 is not distinguished between the image area and the background area, and a uniform potential state may be maintained.

In other words, when emitting the deteriorated toner in the non-forming mode, the potential of the photosensitive element 11 is determined only by relation to the developing bias voltage. That is, the value is not particularly specified, and it is possible either exposure is done or not after charging by the charging device 14. The surface potential of the photosensitive element 11 in this state is called Vpc hereinafter. The value of Vpc is not always equal to Vb or Vi in the image forming mode, but is determined in a specified condition.

In the embodiment, to emit the deteriorated toner, in the non-forming mode, at least one of the direct-current component Vdc, peak-to-peak voltage Vpp, and Duty is changed as compared with the value in the image forming mode. As a result, the area central potential Vav is changed. After change, each value is indicated by a terminal “r” symbol. That is,
Vdcr: Direct-current component of developing bias voltage in the non-forming mode
Vppr: Peak-to-peak voltage of the alternating-current component of developing bias voltage in the non-forming mode
Dutyr: Rate of developing side of one wavelength of developing bias voltage in the non-forming mode
Vavr: Area central potential of developing bias voltage in the non-forming mode

In the embodiment, in the non-forming mode, the difference between area central potential Vavr of developing bias voltage and surface potential of the photosensitive element 11 is shifted to the reverse direction of the toner charging polarity as compared with the difference between area central potential Vav of developing bias voltage in the image forming mode and surface potential Vi in the image area of the photosensitive element 11. In the embodiment, since the toner of the negative charging polarity is used, the reverse direction of the toner charging polarity corresponds to the positive side. That is, in the image forming device 1 of the embodiment, in the non-forming mode, a developing bias voltage Vavr satisfying the relation of expression [1] is applied.

Vavr−Vpc>Vav−Vi [1]

To satisfy expression [1], supposing Vpp=Vi, it is desired to set

Vavr>Vav

For this purpose, in the image forming device 1 using the developing bias as shown in the example above, the developing bias voltage to be applied in the non-forming mode is changed, as compared with the developing bias voltage in the image forming mode, (1) to decrease Duty, (2) to increase Vpp, or (3) to increase Vdc (to shift to the positive side).

For example, the surface potential Vpc of the photosensitive element 11 is equal to Vi, and Duty is decreased. That is,

Dutyr<Duty

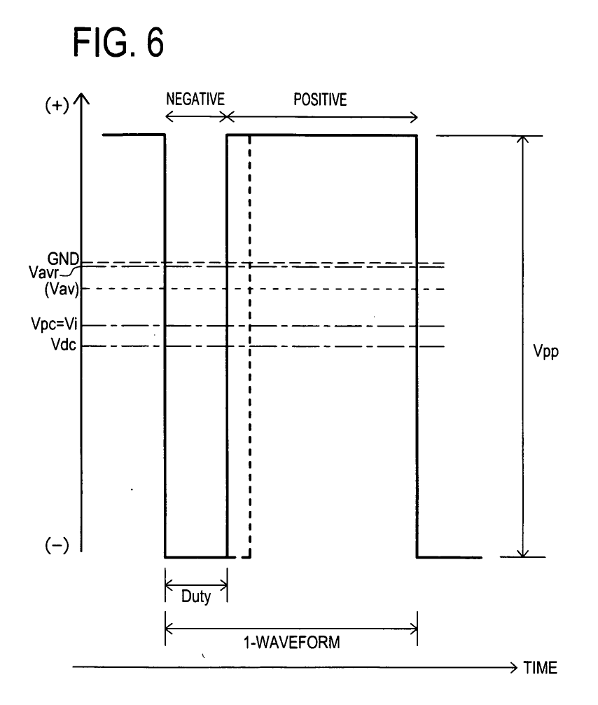

As a result, as shown in FIG. 6, Vavr satisfies the condition of expression [1].

Alternatively, the surface potential Vpc of the photosensitive element 11 is equal to Vi, and Vpp is increased. That is,

Vppr>Vpp

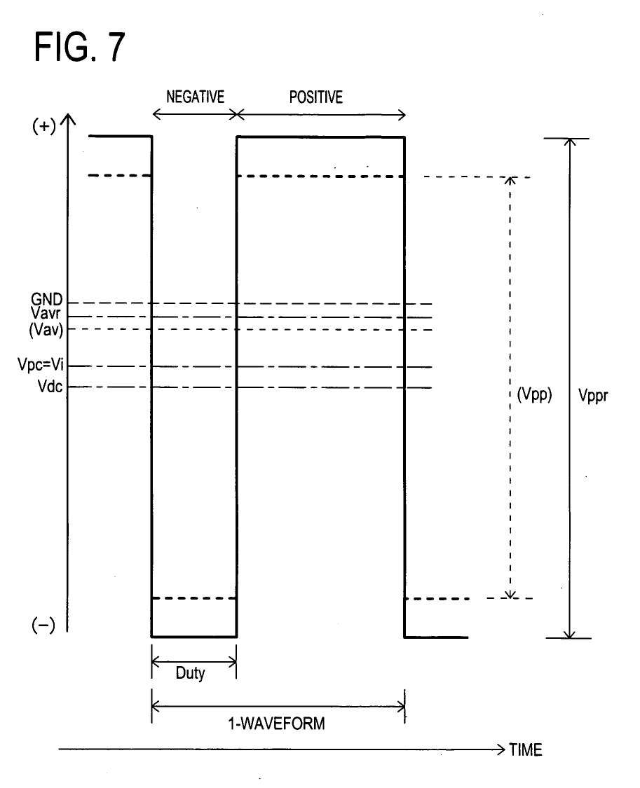

As a result, as shown in FIG. 7, Vavr satisfies the condition of expression [1].

Or, the surface potential Vpc of the photosensitive element 11 is equal to Vi, and Vdc is increased (shifted to the positive side). That is,

Vdcr>Vdc (or |Vdcr|<|Vdc|)

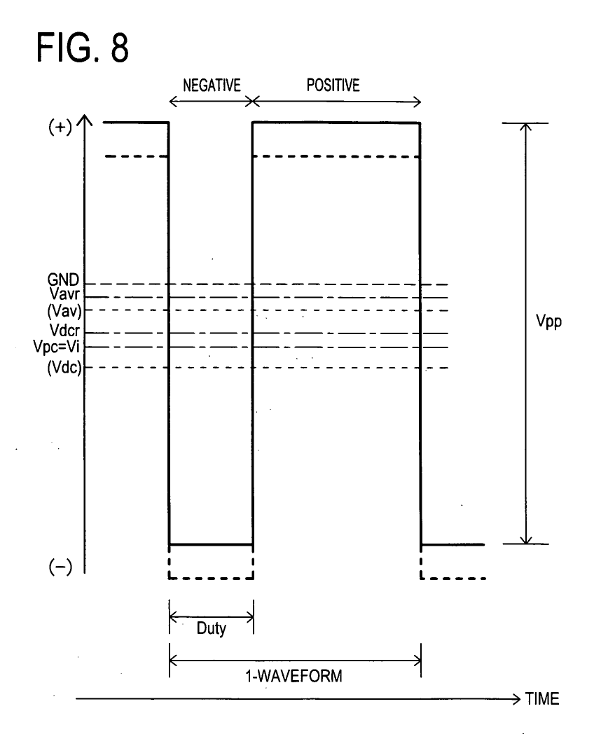

As a result, as shown in FIG. 8, Vavr satisfies the condition of expression [1]. As a result of such setting, ΔV is increased. It is because ΔV is equal to (Vdc−Vi) in the image forming mode, and (Vdcr−Vpc) in the non-forming mode.

In other method, to satisfy the condition of expression [1], without changing the developing bias voltage, the surface potential Vpc of the photosensitive element 11 may be set to a different surface potential from Vi. In this context, since the toner of the negative charging polarity is used, the surface potential of the photosensitive element 11 is negative potential in the image area and the background area. Hence, to satisfy the condition of expression [1] without changing the developing bias voltage, the relation is set as follows:

Vpc<Vi

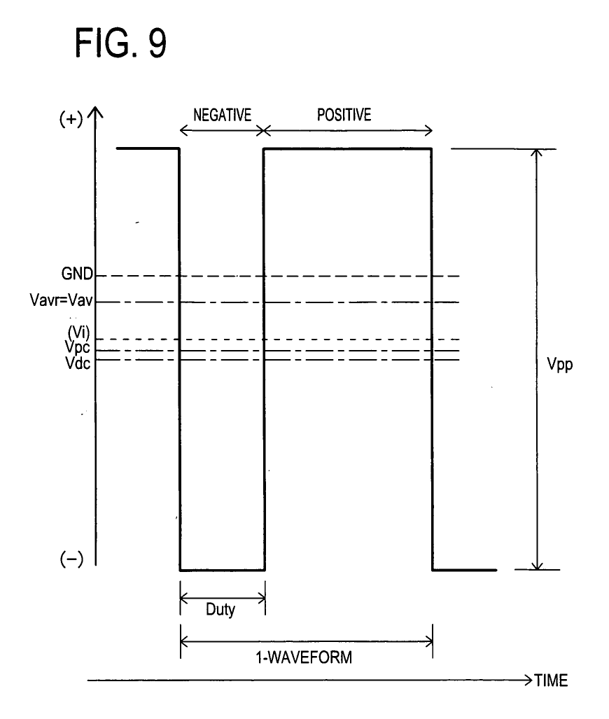

As a result, as shown in FIG. 9, the condition of expression [1] can be satisfied.

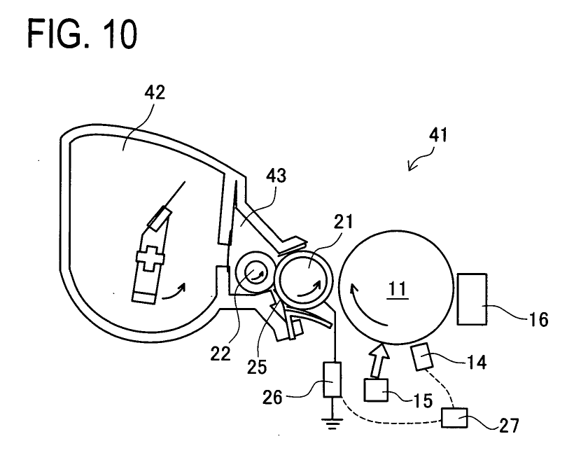

Moreover, the inventor succeeded in obtaining examples of developing bias voltage capable of discarding the deteriorated toner more effectively by combination of the above conditions. This experiment is explained. First, using an imaging unit 41 as shown in FIG. 10, a deteriorated toner was prepared intentionally, and a deteriorated toner discarding experiment was conducted. This imaging unit 41 is a disposable type, integrally provided with a hopper 42 and a buffer 43. Hence, the hopper 42 is not exchangeable alone, or the toner cannot be added into the hopper 42. A basic structure is same as the developing device 12 shown in FIG. 1 excepting that the shape of the buffer 43 is different. Same members as in the developing device 12 are identified with same reference numerals, and their explanation is omitted.

In the experiment, the imaging unit 41 was mounted on a printer “Magicolor 2500” manufactured by Konica-Minolta Business Technologies Inc., and the developing conditions were set as follows, and the operation was stopped in the midst of image forming process. At this time, it was visually recognized that the toner was supplied in the latent image section on the photosensitive element 11. The imaging unit 41 used in the experiment is characterized by diameter of the photosensitive element 11 of 30 mm, diameter of the developing roller 21 of 16 mm, and closest distance between the photosensitive element 11 and the developing roller 21 of 135 μm.

Developing condition in the image forming mode:

Vi=−50 (V)

Vb=−450 (V)

Vdc=−320 (V)

Vpp=1400 (V)

Duty=35 (%)

Vav=−110 (V)

Vav−Vi=−60 (V)

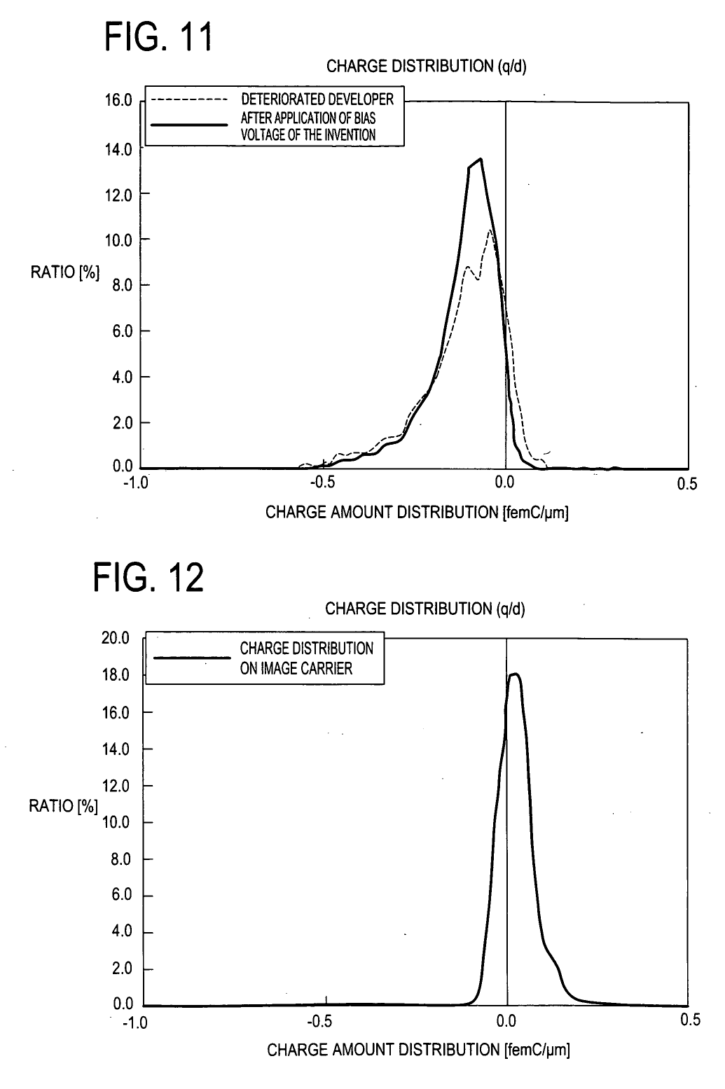

Next, the imaging unit 41 was set in a condition wherein a proper amount of the toner is contained in the buffer 43, and toner is not supplied more to the buffer 43 from the hopper 42. The photosensitive element 11 was dismounted, and the developing roller 21 was continuously driven for 30 minutes while applying the specified developing bias. As a result, the toner contained in the buffer 43 was changed to a deteriorated toner containing a large portion of the weakly-charged toner and the inverted toner. In this state, the charge amount distribution of the deteriorated toner was measured. The result is indicated by the broken line in FIG. 11. In this measurement of the charge amount distribution and in similar measurement of charge amount distribution in the following examples, E-spart Analyzer manufactured by Hosokawa Micron Corporation was used.

By using this deteriorated toner, a thin film was formed on the developing roller 21, and then the developing roller 21 was dismounted. Further, using a blank device for experiment not provided with the regulating member 25 or the supply roller 22, the developing roller 21 and the photosensitive element 11 were disposed at specified positions. The developing roller 21 and the photosensitive element 11 were rotated while the developing bias voltage of the invention was applied to the developing roller 21. Then charge amount distribution of the toner on the developing roller 21 was measured.

In example 1, the following developing bias voltages were applied, and an experiment was conducted, and the result is shown in FIG. 11. The thick line in the diagram refers to charge amount distribution of the toner left over on the developing roller 21 after application of developing bias voltage in this example.

### EXAMPLE 1

Vpc=−50 (V)

Vdcr=−320 (V)

Vppr=1400 (V)

Dutyr=20 (%)

Vavr=100 (V)

Vavr−Vpc=150 (V)

The deteriorated toner contains a high rate of the weakly-charged toner and the inverted toner. Accordingly, as indicated by the broken line in FIG. 11, the hill on the graph was low and moderate on the whole. By contrast, after application of developing bias voltage in the example, the charge amount distribution of the toner left over on the developing roller 21 was decreased in the rate of the weakly-charged toner or the inverted toner, and the rate of the toner of normal charge amount got higher, and a sharp hill was observed. At this time, the charge amount distribution of the toner remaining on the photosensitive element 11 was also measured. The result is shown in FIG. 12. As known from this diagram, on the photosensitive element 11, the deteriorated toner containing a very high rate of the weakly-charged toner and the inverted toner was selectively left over.

As known from these results, it was confirmed that the toner of normal charge amount was collected on the developing roller 21, while the weakly-charged toner and inverted toner were left over on the photosensitive element 11, by application of developing bias voltage of the invention. Therefore, by collecting the residual toner on the photosensitive element 11 by application of developing bias voltage of the invention by the cleaner 16, the toner charging characteristic of the entire unit may be improved.

This emission amount is considerably smaller as compared with the toner discarding amount by the conventional forced discarding method. The inventor also confirmed that the toner consumption is decreased on the whole by application of developing bias voltage of the invention, as compared with continuous printing only by application of ordinary developing bias voltage without application of developing bias voltage of the invention. By continuous printing only by application of ordinary developing bias voltage, the toner consumption by image fogging is increased gradually. According to the invention, by contrast, image fogging may be prevented, and hence the toner consumption is saved.

The timing of application of developing bias voltage of the invention is not specified, and the voltage may be always applied in the non-forming mode, or if applied in a certain period in the non-forming mode, the discarding effect of the deteriorated toner may be obtained. In the case of an imaging cartridge of an additional replenishing type (such as the type shown in FIG. 1), it is preferred to apply for about 1 minute after every toner supply from the hopper into the buffer. The voltage may be also applied after printing every specific number of copies, or after printing of image data low in image density. In the non-forming mode excepting the application period of developing bias voltage of the invention, no developing bias voltage may be applied. And further, driving of the developing roller 21 may be stopped.

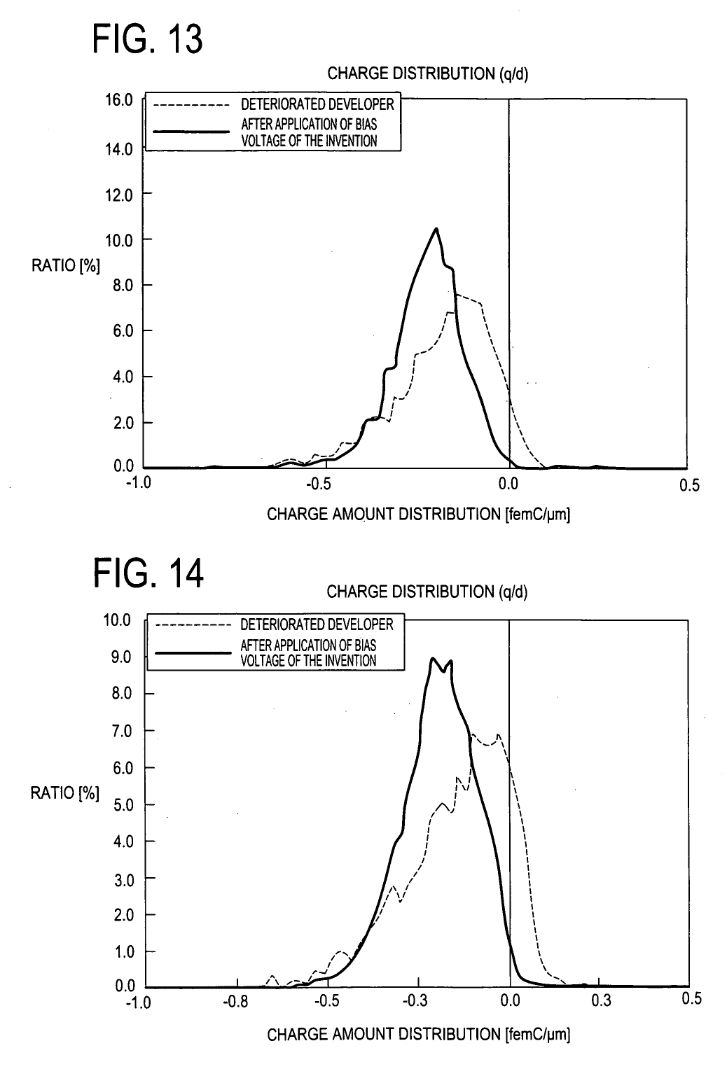

The inventor also executed several experiments on developing bias voltages other than in example 1 shown in FIG. 11, and confirmed the effects of the invention. In example 2, the following developing bias voltages were applied. Results are shown in FIG. 13. The broken line refers to the charge amount distribution of the deteriorated toner. Consequently, same as in the procedure of example 1, the following developing bias voltages were applied, and the charge amount distribution of the toner on the developing roller 21 became as indicated by the thick line in the diagram.

### EXAMPLE 2

Vpc=0 (V)

Vdcr=−270 (V)

Vppr=1600 (V)

Dutyr=20 (%)

Vavr=160 (V)

Vavr−Vpc=160 (V)

In example 3, the following developing bias voltages were applied. Results are shown in FIG. 14. The broken line refers to the charge amount distribution of the deteriorated toner. Consequently, same as in the procedure of example 1, the following developing bias voltages were applied, and the charge amount distribution of the toner on the developing roller 21 became as indicated by the thick line in the diagram.

### EXAMPLE 3

Vpc=−200 (V)

Vdcr=−4700 (V)

Vppr=1600 (V)

Dutyr=25 (%)

Vavr=80 (V)

Vavr−Vpc=280 (V)

The following developing bias voltages were applied, and same effects were confirmed.

### EXAMPLE 4

Vpc=−50 (V)

Vdcr=−320 (V)

Vppr=1600 (V)

Dutyr=20 (%)

Cavr=160 (V)

Vavr−Vpc=210 (V)

The following developing bias voltages were applied, and same effects were confirmed.

### EXAMPLE 5

Vpc=−400 (V)

Vdcr=−670 (V)

Vppr=1600 (V)

Dutyr=20 (%)

Vavr=−190 (V)

Vavr−Vpc=210 (V)

The setting of developing bias voltages in examples 1 to 5 was applied in the “Magicolor 2500”, and the toner amount supplied on the photosensitive element 11 was sufficiently smaller than the amount on the image area in the image forming mode. The presence of the toner on the photosensitive element 11 was not observed grossly, and only a slight amount was recognized by an optical microscope. That is, the setting of developing bias voltages in examples 1 to 5 was confirmed to correspond to “region of almost no image density”.

As described herein, in the image forming device 1 of the embodiment, a developing bias voltage for discarding the deteriorated toner is set at least in a certain period in the non-forming mode. That is, the amplitude of the alternating-current component corresponds to 9 V/μm or more, and the difference between area central potential Vavr and the surface potential Vpc of the photosensitive element 11 is at the positive side (reverse to the toner charging polarity) in relation to the difference in the latent image area in the image forming mode. It is also set so that the supply amount of the toner on the photosensitive element 11 may be smaller than the supply amount of the toner on the latent image area of the photosensitive element 11 in the image forming mode.

Accordingly, the toner of normal charge amount travels to and fro many times between the developing roller 21 and the photosensitive element 11. The deteriorated toner flies up to the photosensitive element 11 together with the toner of normal charge amount, and when once departed from the toner of normal charge amount, it cannot return by itself. The majority of the toner of normal charge amount is finally collected on the developing roller 21 by the developing bias voltage. As a result, only the majority of the deteriorated toner is left over selectively on the photosensitive element 11. Therefore, without excessively spending the toner, the inverted toner and the weakly-charged toner are selectively discarded, and the toner charging characteristic may be maintained in a favorable state.

The developing device of the present invention comprises a developer carrier for carrying charged nonmagnetic mono-component developer and conveying the developer toward a developing region opposite to an image carrier across a gap, and a bias power source for applying bias voltage including an alternating-current component to the developer carrier to develop a latent image on the image carrier, and the developing device may be arranged so that the bias power source is arranged:
to set the bias voltage in an image forming mode so that an amplitude of the alternating-current component is equal to or larger than a value corresponding to a developing electric field of 9 V/μm, and a latent image on the image carrier is developed by applying with developer; and
to set the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted in a reverse direction to a normally charging polarity of the developer carrier, in relation to a difference between an area central potential and a surface potential of the image carrier in a latent image section in the image forming mode; and an amount of the developer to be supplied to the image carrier is smaller than that in the latent image section in the image forming mode.

The image forming device comprising an image carrier, a charging device for charging a surface of the image carrier, an exposing device for exposing the charged image carrier and a developing device for developing a latent image on the image carrier, the developing device including a developer carrier for carrying charged nonmagnetic mono-component developer and conveying the developer toward a developing region opposite to an image carrier across a gap, and a bias power source for applying a bias voltage including an alternating-current component to the developer carrier, and the image forming device may be arranged so that the bias power source is arranged:
to set the bias voltage in an image forming mode so that an amplitude of the alternating-current component is equal to or larger than a value corresponding to a developing electric field of 9 V/μm, and a latent image on the image carrier is developed by applying with developer; and
to set the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted in a reverse direction to a normally charging polarity of the developer carrier, in relation to the difference between an area central potential and a surface potential of the image carrier in a latent image section in the image forming mode; and an amount of the developer to be supplied to the image carrier is smaller than that in the latent image section in the image forming mode.

The image forming method for forming an image in such a manner that charged nonmagnetic mono-component developer is carried by a developer carrier placed opposite to an image carrier across a gap, the developer is conveyed toward a developing region of the image carrier, and bias voltage including an alternating-current component is applied to the developer carrier to develop a latent image on the image carrier, and the method may comprise the steps of:
setting the bias voltage in an image forming mode so that an amplitude of the alternating-current component is equal to or larger than a value corresponding to a developing electric field of 9 V/μm, and a latent image on the image carrier is developed by applying with developer; and
setting the bias voltage at least in a certain period of a non-forming mode so that an amplitude of the alternating-current component is equal to or larger than a value corresponding to the developing an electric field of 9 V/μm, a difference between an area central potential and a surface potential of the image carrier is shifted in a reverse direction to a normally charging polarity of the developer carrier, in relation to a difference between an area central potential and a surface potential of the image carrier in a latent image section in the image forming mode; and an amount of the developer to be supplied to the image carrier is smaller than that in the latent image section in the image forming mode.

According to the developing device of the invention, the developer carrier carries and conveys the charged nonmagnetic mono-component developer, and a bias voltage is applied by the bias power source. This bias voltage has the amplitude of its alternating-current component equivalent to 9 V/μm or more, and can move the toner to the opposite image carrier across the gap. In this respect, it is the same in both the image forming mode and the non-forming mode. In the invention, the alternating-current component is not specified by waveform, but includes various forms alternately repeated between positive and negative voltages. For example, a sinusoidal wave, a rectangular wave, and a triangular wave are included.

In this context, the area central potential of bias voltage in at least a certain period of the non-forming mode is set to a value of the difference of the area central potential and the surface potential of the image carrier shifted to a direction attracting normally charged developer to the developer carrier, in relation to the difference between an area central potential and a surface potential of the image carrier in the latent image area in the image forming mode. Therefore, when setting in such manner, the developer of normal charge amount is mostly collected on the developer carrier. On the other hand, the deteriorated developer such as the inverted toner and the weakly-charged toner does not have enough energy for surpassing the gap by itself, and is selectively left over on the image carrier. Therefore, without excessively spending the toner, the inverted toner or the weakly-charged toner may be discarded selectively, and the toner charging characteristic may be held in a favorable state.

Therefore, when forming an image, the condition can be set to develop by adhering the developer to the latent image on the image carrier, and a favorable image may be formed. At least in a certain period of the non-forming mode, the supply amount of the developer on the image carrier may be set to be smaller than the supply amount of the developer on the latent image section of the image carrier in the image forming mode, so that the toner is not consumed excessively. In the invention, when discarding the deteriorated developer in the non-forming mode, the discarded amount is much smaller than the supply amount of the developer on the latent image in the image forming mode, about 1/100 or less.

In the invention, preferably, the bias power source sets the amplitude of the alternating-current component of bias voltage in the non-forming mode larger than that in the image forming mode. As a result, only by setting the amplitude of the alternating-current component of the bias voltage, the area central potential of the bias voltage can be adjusted properly. Further, other conditions may be also determined.

In the invention, preferably, the bias power source sets the developing side duty ratio of the alternating-current component of bias voltage in the non-forming mode smaller than that in the image forming mode. As a result, only by setting the developing side duty ratio of the bias voltage, the area central potential of the bias voltage can be adjusted properly. Further, other conditions may be also determined.

In the invention, preferably, the bias power source sets the absolute value of difference between the direct-current component of bias voltage and the surface potential of the image carrier in the non-forming mode smaller than that in the latent image section in the image forming mode. As a result, only by setting the direct-current component of the bias voltage, the area central potential of the bias voltage can be adjusted properly. Further, other conditions may be also determined.

In the invention, preferably, the charging device charges the surface of the image carrier in the non-forming mode in a different surface potential from in the image forming mode, and the absolute value of a difference between the direct-current component of bias voltage and the surface potential of the image carrier may be set smaller than the absolute value of a difference between the direct-current component of bias voltage and the surface potential in the latent image section of the image carrier in the image forming mode. As a result, it is easy to adjust the relation between area central potential of bias voltage and the surface potential of the image carrier in an appropriate range.

In the invention, preferably, the bias power source sets the direct-current component of bias voltage in the non-forming mode at a different voltage from that in the image forming mode, and the absolute value of a difference between the direct-current component of bias voltage and the surface potential of the image carrier may be set smaller than the absolute value of difference between the direct-current component of bias voltage and the surface potential in the latent image section of the image carrier in the image forming mode. As a result, it is easy to adjust the relation of area central potential of bias voltage and surface potential of the image carrier in an appropriate range.

The embodiment is a mere exemplary embodiment, and is not intended to specify the invention in any aspect. Hence, the invention may be freely changed and modified within a scope not departing from the true spirit thereof.

For example, the configuration of the illustrated image forming device is a mere example, and is not particularly specified as far as the developing roller and the photosensitive element are not in mutual contact, and the configuration is not particularly limited. In the embodiment, an example of negative charge toner is explained, but the invention may be also applied in a developing device using positively charged toner. In such a case, the polarity of the developing bias voltage may be inverted. The invention is further applicable in monochromatic and color copiers, printers, facsimile apparatus, and other image forming devices.

What is claimed is:

1. A developing device comprising a developer carrier for carrying charged nonmagnetic mono-component developer and conveying the developer toward a developing region opposite to an image carrier across a gap, and a bias power source for applying bias voltage including an alternating-current component to the developer carrier to develop a latent image on the image carrier, wherein the bias power source is arranged:
to set the bias voltage in an image forming mode so that
an amplitude of the alternating-current component is equal to or larger than a value corresponding to a developing electric field of 9 V/μm, and
a latent image on the image carrier is developed by applying with developer; and
to set the bias voltage at least in a certain period of a non-forming mode so that
an amplitude of the alternating-current component is equal to or larger than a value corresponding to the developing an electric field of 9 V/μm,
a difference between an area central potential and a surface potential of the image carrier is shifted to a direction attracting normally charged developer to the developer carrier, in relation to a difference between an area central potential and a surface potential of the image carrier in a latent image section in the image forming mode; and
an amount of the developer to be supplied to the image carrier is smaller than that in the latent image section in the image forming mode.

2. The developing device according to claim 1, wherein
the bias power source sets the amplitude of the alternating-current component of bias voltage in the non-forming mode to be larger than that in the image forming mode.

3. The developing device according to claim 1, wherein
the bias power source sets a developing side duty ratio of the alternating-current component of bias voltage in the non-forming mode to be smaller than that in the image forming mode.

4. The developing device according to claim 1, wherein
the bias power source sets an absolute value of a difference between a direct-current component of bias voltage and the surface potential of the image carrier in the non-forming mode to be smaller than that in a latent image section in the image forming mode.

5. An image forming device comprising an image carrier, a charging device for charging a surface of the image carrier, an exposing device for exposing the charged image carrier and a developing device for developing a latent image on the image carrier, the developing device including a developer carrier for carrying charged nonmagnetic mono-component developer and conveying the developer toward a developing region opposite to an image carrier across a gap, and a bias power source for applying a bias voltage including an alternating-current component to the developer carrier, wherein the bias power source is arranged:
to set the bias voltage in an image forming mode so that
an amplitude of the alternating-current component is equal to or larger than a value corresponding to a developing electric field of 9 V/μm, and
a latent image on the image carrier is developed by applying with developer; and
to set the bias voltage at least in a certain period of a non-forming mode so that
an amplitude of the alternating-current component is equal to or larger than a value corresponding to the developing an electric field of 9 V/μm,
a difference between an area central potential and a surface potential of the image carrier is shifted to a direction attracting normally charged developer to the developer carrier, in relation to the difference between an area central potential and a surface potential of the image carrier in a latent image section in the image forming mode; and
an amount of the developer to be supplied to the image carrier is smaller than that in the latent image section in the image forming mode.

6. The image forming device according to claim 5, wherein
the bias power source sets the amplitude of the alternating-current component of bias voltage in the non-forming mode to be larger than that in the image forming mode.

7. The image forming device according to claim 5, wherein
the bias power source sets a developing side duty ratio of the alternating-current component of bias voltage in the non-forming mode to be smaller than that in the image forming mode.

8. The image forming device according to claim 5, wherein
the bias power source sets an absolute value of a difference between a direct-current component of bias voltage and the surface potential of the image carrier in the non-forming mode to be smaller than that in a latent image section in the image forming mode.

9. The image forming g device according to claim 8, wherein
the charging device charges the surface of the image carrier at a different surface potential from that in the image forming mode when the bias power source sets the absolute value of the difference between the direct-current component of bias voltage and the surface potential of the image carrier in the non-forming mode to be smaller than that in the latent image section in the image forming mode.

10. The image forming device according to claim 8, wherein
the bias power source sets the direct-current component of bias voltage to a different voltage from that in the image forming mode when the bias power source sets the absolute value of the difference between the direct-current component of bias voltage and the surface potential of the image carrier in the non-forming mode to be smaller than that in the latent image section in the image forming mode.

11. An image forming method for forming an image in such a manner that charged nonmagnetic mono-component developer is carried by a developer carrier placed opposite to an image carrier across a gap, the developer is conveyed toward a developing region of the image carrier, and bias voltage including an alternating-current component is applied to the developer carrier to develop a latent image on the image carrier, the method comprising the steps of:
setting the bias voltage in an image forming mode so that
an amplitude of the alternating-current component is equal to or larger than a value corresponding to a developing electric field of 9 V/μm, and
a latent image on the image carrier is developed by applying with developer; and
setting the bias voltage at least in a certain period of a non-forming mode so that
an amplitude of the alternating-current component is equal to or larger than a value corresponding to the developing an electric field of 9 V/μm,
a difference between an area central potential and a surface potential of the image carrier is shifted to a direction attracting normally charged developer to the developer carrier, in relation to a difference between an area central potential and a surface potential of the image carrier in a latent image section in the image forming mode; and
an amount of the developer to be supplied to the image carrier is smaller than that in the latent image section in the image forming mode.

12. The image forming method according to claim 11, wherein
the amplitude of the alternating-current component of bias voltage in the non-forming mode is set to be larger than that in the image forming mode.

13. The image forming method according to claim 11, wherein
a developing side duty ratio of the alternating-current component of bias voltage in the non-forming mode is set to be smaller than that in the image forming mode.

14. The image forming method according to claim 11, wherein
an absolute value of a difference between a direct-current component of bias voltage and the surface potential of the image carrier in the non-forming mode is set to be smaller than that in a latent image section in the image forming mode.

15. The image forming method according to claim 14, wherein
the surface of the image carrier is charged at a different surface potential from that in the image forming mode when the absolute value of the difference between the direct-current component of bias voltage and the surface potential of the image carrier in the non-forming mode is set to be smaller than that in the latent image section in the image forming mode.

16. The image forming method according to claim 14, wherein
the direct-current component of bias voltage is set to a different voltage from that in the image forming mode when the absolute value of the difference between the direct-current component of bias voltage and the surface potential of the image carrier in the non-forming mode is set to be smaller than that in the latent image section in the image forming mode.
